(19) United States
(12) Patent Application Publication
(10) Pub. No.: US 2024/0360034 A1
(43) Pub. Date: Oct. 31, 2024

(54) METHOD FOR PREPARING GENERAL-PURPOSE CEMENT

(71) Applicants: HUNAN UNIVERSITY OF SCIENCE AND TECHNOLOGY, Xiangtan (CN); HUNAN XIANGCHU XIANLU ENVIRONMENTAL PROTECTION TECHNOLOGY CO., LTD., Changsha (CN)

(72) Inventors: Meixun PENG, Xiangtan (CN); Yuanpeng ZHANG, Xiangtan (CN); Qiming ZHAO, Xiangtan (CN); Wenwei LIU, Changsha (CN); Meilin CHEN, Changsha (CN)

(21) Appl. No.: 18/769,533

(22) Filed: Jul. 11, 2024

(30) Foreign Application Priority Data
Feb. 24, 2024 (CN) 202410204516.1

(51) Int. Cl. C04B 7/42; C04B 7/43; C04B 7/47; C04B 7/52; C04B 111/00

(52) U.S. Cl. CPC C04B 7/424; C04B 7/434; C04B 7/47; C04B 7/527; C04B 2111/00017

(57) ABSTRACT

A method for preparing a general-purpose cement is provided. Raw materials containing all of SiO₂, Al₂O₃, CaO, MgO and Na₂O (or K₂O) are mixed to obtain a raw meal, which is dried and ground into a raw meal powder. The raw meal powder is oxidatively calcined at no less than 1210° C. to reach a stable phase state, and rapidly cooled to obtain a clinker predominated by glass phase. The clinker is mixed with NaOH, KOH or a combination thereof and ground to obtain the general-purpose cement. Alternatively, the clinker is ground to obtain a clinker powder, which is mixed with an aqueous NaOH solution, an aqueous KOH solution or a combination thereof for use. The NaOH and/or KOH is/are added such that a weight ratio of NaOH+0.713KOH to the clinker powder is 0-0.03:1.

### CROSS-REFERENCE TO RELATED APPLICATIONS

This application claims the benefit of priority from Chinese Patent Application No. 202410204516.1, filed on Feb. 24, 2024. The content of the aforementioned application, including any intervening amendments made thereto, is incorporated herein by reference in its entirety.

### TECHNICAL FIELD

This application relates to cement-type building materials, and more particularly to a method for preparing a general-purpose cement.

### BACKGROUND

The rapid development of economy brings more and more bulk solid wastes. The storage of the bulk solid wastes not only occupies a large amount of land, but also leads to serious geological disaster risks and pollution to the environment including soil, water system and air. At present, the main method for effectively utilizing the bulk solid wastes is to prepare building materials, including general-purpose cement. The existing general-purpose cement is made of Portland cement clinker mixed with a small amount of gypsum and other mixed materials. Most of the bulk solid wastes are aluminosilicates mainly composed of SiO₂ and Al₂O₃. However, due to its chemical composition of high calcium and low silicon and aluminum, Portland cement has a high carbon emission, and dispose of aluminosilicate wastes with a low mixing content. Moreover, the aluminosilicate wastes containing excessive amounts of alkali metal oxides and MgO cannot be used to prepare Portland cement.

The research and development of low-carbon and environmentally friendly general-purpose cement with high aluminosilicate wastes disposal capacity to replace Portland cement has been the direction of the cement industry. Alkali-activated cement has outstanding advantages such as early strength, corrosion resistance and excellent freeze-thaw resistance. It can make use of a large amount of solid wastes, leading to low carbon emission, energy saving and environmental protection, and is one of the new cements most likely to replace Portland cement. Traditional alkali-activated cement is a two-component cement that is hardened by using strong alkali to activate active amorphous (calcium) aluminosilicates, which still has many shortcomings. 1) Kaolinite resources are scarce, and other main raw materials such as fly ash and blast furnace slag have risen in price due to their large-scale use as admixtures of Portland cement. 2) The addition of a large amount of industrial alkali activator (3-14 wt % in terms of Na₂O) also leads to high cost and easy efflorescence, thereby affecting durability. 3) Processing methodologies and properties for AACs derived from solid waste precursors are difficult to standardize due to variations in chemical composition and properties.

The reduction and elimination of the use of alkali activators can effectively reduce the cost of alkali-activated cement. Chinese patent publication No. 110451827A disclosed preparation and use of a steam-curing alkali-activated cement, and Chinese patent publication No. 110372240A disclosed preparation and use of a room temperature-curing alkali-activated cement. A small amount of industrial alkali was mixed with potassium sodium aluminosilicate and calcium raw materials, ground and calcined at 1250-1300° C. before rapidly cooled to obtain a clinker. The clinker was ground and evenly mixed with sodium water glass to obtain the cement. The 28-day compressive strengths of the resulting cement pastes exceed 80 MPa and 110 MPa respectively. The above alkali-activated cements have a lower dosage of the alkali activator compared to the commonly used two-component alkali-activated cement, but still failed to completely eliminate the alkali activator.

### SUMMARY

An object of the disclosure is to provide a method for preparing a general-purpose cement, which can significantly reduce cement carbon emission and save non-renewable high-quality limestone resources, and requires little or no alkali for activation.

In order to achieve the above object, the following technical solutions are adopted.

This application provides a method for preparing a general-purpose cement, comprising:
step (1) mixing one or more raw materials to obtain a raw meal containing SiO₂, Al₂O₃, CaO, MgO, and Na₂O or K₂O; and subjecting the raw meal to drying and grinding to obtain a raw meal powder;
step (2) oxidatively calcining the raw meal powder at no less than 1210° C. until a stable phase state is reached, followed by cooling to obtain a clinker predominated by a glass phase;
wherein a mass percentage of SiO₂+Al₂O₃+Fe₂O₃+CaO+MgO+Na₂O+K₂O in the clinker is no less than 93%, and in every 100 parts (by mass) of SiO₂+Al₂O₃+Fe₂O₃+CaO+MgO+Na₂O+K₂O, a mass parts distribution is: SiO₂ 31.5˜44.8, Al₂O₃ 6.1˜19.9, Fe₂O₃0˜6.2, CaO 22.5˜45.0, MgO 1.2˜16.0, Na₂O+K₂O 1.0˜8.3;
step (3) mixing the clinker with NaOH, KOH or a combination thereof followed by grinding to obtain the general-purpose cement; or
grinding the clinker to obtain a clinker powder, and mixing the clinker powder with a NaOH aqueous solution, a KOH aqueous solution or a combination thereof for use;
wherein NaOH, KOH or a combination thereof is added such that a weight ratio of NaOH+0.713KOH to the clinker is 0-0.03:1.

In some embodiments, in the clinker, a weight ratio of CaO+MgO to SiO₂+Al₂O₃ is 0.6-1.0:1.

In some embodiments, in the clinker, a weight ratio of SiO₂ to Al₂O₃ is 2.0-7.0:1.

In some embodiments, in the clinker, a weight ratio of MgO to CaO is 0.03-0.66:1.

In some embodiments, in step (2), the cooling is performed by air blast cooling or water quenching.

In some embodiments, in step (3), a weight percentage of a sieve residue of the general-purpose cement is no more than 5% after passing through a 75-μm square hole sieve; and a weight percentage of a sieve residue of the clinker powder is no more than 5% after passing through the 75-μm square hole sieve.

In some embodiments, after hydration, the general-purpose cement is subjected to steam curing at room temperature for no less than 7 days and then subjected to water curing.

Compared with the prior art, this application has the following beneficial effects.
1. Compared with Portland cement, the clinker of the general-purpose cement of the present disclosure has a significantly reduced content of calcium oxide and magnesium, such that the cement carbon emission is significantly reduced, and the non-renewable high-quality limestone resources are saved.
2. Aluminosilicate is used as a main raw material for preparing the general-purpose cement. Compared with Portland cement, aluminosilicate wastes can be used as the raw material with larger quantities, resulting in a high waste utilization rate and an excellent sustainability.
3. A content of alkali metal oxides in the clinker can be as low as 1.0%, and little or no alkali is required for activation, thereby eliminating an alkali efflorescence phenomenon of a cement product. This not only improves the cement durability, but also facilitates the use of the general-purpose cement as a decorative cement.
4. A firing temperature of the clinker of the general-purpose cement can be as low as 1210° C., which is much lower than a firing temperature of 1450° C. for Portland cement, thus achieving better energy-saving effect.

### DETAILED DESCRIPTION OF EMBODIMENTS

The present disclosure will be further described below in conjunction with the embodiments, but the scope of the present disclosure is not limited thereto.

### EXAMPLES

### (1) Clinker Preparation and Grinding

According to the difference in chemical composition, raw materials of raw meal including 12 types of potassium sodium aluminosilicate, kaolinite, analytical pure sodium carbonate, calcium carbonate, silicon dioxide (quartz), iron oxide and natural dolomite listed in Table 1 were prepared. The above raw materials were dried at 105° C. to constant weight and subjected to chemical composition detection, with the detection results listed in Table 1. In Examples 1-14, the raw materials of each raw meal were mixed according to formulas shown in Table 2, and ground to obtain a raw meal powder. A weight percentage of a sieve residue of raw meal powder was no more than 10% after passing through a 75-μm square hole sieve. The raw meal powder was placed in a corundum crucible, calcinated under heating in a silicon carbide muffle furnace with a heating rate of 10° C./min, and kept at a constant temperature for 1, 2 and 3 h at 1210-1350° C., respectively. After the temperature keeping was completed, the corundum crucible was immediately taken out of the silicon carbide muffle furnace and rapidly cooled by air blast cooling or water quenching to obtain a clinker predominated by a glass phase. The clinker was ground to obtain a clinker powder. A weight percentage of a sieve residue of the clinker powder was no more than 5% after passing through the 75-μm square hole sieve. By means of a powder X-ray diffraction method, it was found that when a temperature keeping time of the same raw material at a highest calcination temperature was changed, the phase characteristics of clinker samples kept at the constant temperature for 2 h and 3 h were the same, while there were some differences in clinker samples kept at the constant temperature for 1 h. Therefore, the temperature keeping time at the highest temperature during clinker calcination was determined as 2 h. A total weight percentage of SiO₂, Al₂O₃, Fe₂O₃, CaO, MgO, Na₂O and K₂O in the clinker powder was no less than 93%, and in every 100 parts (by mass) of SiO₂+Al₂O₃+Fe₂O₃+CaO+MgO+Na₂O+K₂O, a mass parts distribution is: SiO₂ 31.5˜44.8, Al₂O₃ 6.1˜19.9, Fe₂O₃ 0˜6.2, CaO 22.5˜45.0, MgO 1.2˜16.0, Na₂O+K₂O 1.0˜8.3, and a weight ratio of CaO+MgO to SiO₂+Al₂O₃ was 0.6-1.0:1, a weight ratio of SiO₂ to Al₂O₃ was 2.0-7.0:1, and a weight ratio of MgO to CaO was 0.03-0.66:1 (see Table 3 for details).

TABLE 1
Chemical composition of raw materials (Unit: wt %)

| Raw materials | | | | | | | | |
|---|---|---|---|---|---|---|---|---|
| of raw meal | SiO₂ | Al₂O₃ | TFe₂O₃ | CaO | MgO | K₂O | Na₂O | Others |
| Potassium sodium | 65.8 | 12.6 | 7.4 | 3.0 | 0.8 | 0.9 | 9.5 | 0.0 |
| aluminosilicate 1 | | | | | | | | |
| Potassium sodium | 58.1 | 25.7 | 3.9 | 1.5 | 0.4 | 0.5 | 9.8 | 0.1 |
| aluminosilicate 2 | | | | | | | | |
| Potassium sodium | 46.7 | 21.2 | 5.8 | 4.0 | 8.5 | 1.6 | 12.3 | 0.0 |
| aluminosilicate 3 | | | | | | | | |
| Potassium sodium | 69.5 | 10.9 | 2.8 | 1.9 | 0.7 | 1.2 | 13.0 | 0.0 |
| aluminosilicate 4 | | | | | | | | |
| Potassium sodium | 72.4 | 8.8 | 1.0 | 3.2 | 0.8 | 0.8 | 13.2 | 0.0 |
| aluminosilicate 5 | | | | | | | | |
| Potassium sodium | 62.5 | 10.4 | 5.6 | 4.4 | 3.7 | 0.8 | 12.6 | 0.0 |
| aluminosilicate 6 | | | | | | | | |
| Potassium sodium | 62.4 | 20.3 | 3.1 | 1.4 | 0.7 | 2.2 | 9.9 | 0.0 |
| aluminosilicate 7 | | | | | | | | |
| Potassium sodium | 72.5 | 13.9 | 0.6 | 1.0 | 0.3 | 0.8 | 11.0 | 0.0 |
| aluminosilicate 8 | | | | | | | | |
| Potassium sodium | 46.6 | 42.7 | 1.5 | 0.4 | 0.4 | 0.5 | 7.9 | 0.0 |
| aluminosilicate 9 | | | | | | | | |
| Potassium sodium | 51.6 | 38.7 | 0.6 | 0.3 | 0.3 | 0.3 | 8.2 | 0.0 |
| aluminosilicate 10 | | | | | | | | |
| Potassium sodium | 48.0 | 27.0 | 4.9 | 0.4 | 0.6 | 6.2 | 12.9 | 0.0 |
| aluminosilicate 11 | | | | | | | | |
| Potassium sodium | 48.8 | 37.3 | 0.2 | 0.2 | 0.1 | 0.2 | 13.2 | 0.0 |
| aluminosilicate 12 | | | | | | | | |
| Kaolinite | 42.7 | 38.3 | 0.5 | 0.3 | 0.3 | 0.6 | 0.5 | 16.7 |
| Dolomite | — | — | — | 31.6 | 20.2 | | | 48.3 |
| Sodium carbonate | — | — | — | | — | — | 58.5 | 41.5 |
| Calcium carbonate | — | — | — | 56.0 | — | — | — | 44.0 |
| Quartz | 100.0 | — | — | — | — | — | — | 0.0 |
| Iron oxide | — | — | 100.0 | — | — | — | — | 0.0 |

Note:
TFe₂O₃ refers to total sum of Fe₂O₃ converted from equivalent iron in different valence states.

TABLE 2
Raw material weight ratios and calcination conditions of cement raw meal (Unit: %)

| | Potassium sodium | | | | | | | | Calcination | Rapid |
|---|---|---|---|---|---|---|---|---|---|---|
| Clinker | aluminosilicate | | | Sodium | Calcium | | Iron | | temperature | cooling |
| No. | No. | Content | Kaolinite | carbonate | carbonate | Quartz | oxide | Dolomite | (° C.) | method |
| 1 | 1 | 3.0 | 35.0 | — | 10.0 | 10.0 | 4.0 | 38.0 | 1300 | Air |
| | | | | | | | | | | cooling |
| 2 | 2 | 45.0 | — | — | 20.0 | 7.0 | — | 28.0 | 1240 | Air |
| | | | | | | | | | | cooling |
| 3 | 3 | 43.0 | — | — | 13.0 | 4.0 | — | 40.0 | 1300 | Water |
| | | | | | | | | | | cooling |
| 4 | 4 | 30.0 | 15.0 | — | — | — | — | 55.0 | 1300 | Air |
| | | | | | | | | | | cooling |
| 5 | 5 | 31.0 | 15.4 | 2.6 | 10.0 | | 1.0 | 40.0 | 1210 | Air |
| | | | | | | | | | | cooling |
| 6 | 6 | 44.0 | 5.0 | — | — | 3.0 | — | 48.0 | 1260 | Water |
| | | | | | | | | | | cooling |
| 7 | 7 | 30.0 | 9.0 | 3.0 | 55.0 | — | — | 3.0 | 1350 | Water |
| | | | | | | | | | | cooling |
| 8 | 8 | 42.0 | 9.0 | 2.0 | 36.0 | — | — | 11.0 | 1250 | Air |
| | | | | | | | | | | cooling |
| 9 | 9 | 10.4 | — | 0.4 | 55.0 | 26.2 | 3.0 | 5.0 | 1300 | Water |
| | | | | | | | | | | cooling |
| 10 | 10 | 14.0 | — | 3.0 | 50.0 | 25.0 | — | 8.0 | 1300 | Water |
| | | | | | | | | | | cooling |
| 11 | 11 | 32.0 | — | — | 50.0 | 13.0 | — | 5.0 | 1300 | Water |
| | | | | | | | | | | cooling |
| 12 | 12 | 12.0 | 20.0 | — | 50.0 | 13.0 | — | 5.0 | 1300 | Water |
| | | | | | | | | | | cooling |
| 13 | 12 | 7.0 | 8.0 | — | 50.0 | 25.0 | — | 10.0 | 1300 | Water |
| | | | | | | | | | | cooling |
| 14 | 12 | 12.0 | 10.0 | — | 50.0 | 23.0 | — | 5.0 | 1300 | Water |
| | | | | | | | | | | cooling |

TABLE 3
Chemical compositions of clinker

| Clinker | Chemical composition ^{a}(wt. %) | | | | | | | | (CaO + MgO)/ | SiO₂/ | MgO/ |
|---|---|---|---|---|---|---|---|---|---|---|---|
| No. | SiO₂ | Al₂O₃ | Fe₂O₃ | CaO | MgO | K₂O | Na₂O | Others | (SiO₂ + Al₂O₃) | Al₂O₃ | CaO |
| 1 | 37.7 | 19.3 | 6.2 | 24.9 | 10.9 | 0.3 | 0.7 | 6.8 | 0.6 | 2.0 | 0.44 |
| 2 | 42.7 | 14.9 | 2.3 | 26.7 | 7.5 | 0.3 | 5.7 | 0.0 | 0.6 | 2.9 | 0.28 |
| 3 | 32.1 | 12.1 | 3.3 | 28.9 | 15.6 | 0.9 | 7.1 | 0.0 | 1.0 | 2.6 | 0.54 |
| 4 | 38.4 | 12.7 | 1.3 | 25.3 | 16.0 | 0.6 | 5.6 | 3.1 | 0.8 | 3.0 | 0.63 |
| 5 | 39.9 | 11.9 | 1.9 | 26.5 | 11.5 | 0.5 | 7.8 | 3.1 | 0.7 | 3.4 | 0.43 |
| 6 | 42.9 | 8.5 | 3.3 | 22.5 | 14.9 | 0.5 | 7.3 | 1.0 | 0.7 | 5.0 | 0.66 |
| 7 | 31.5 | 13.3 | 1.4 | 45.0 | 1.2 | 1.0 | 6.6 | 1.9 | 1.0 | 2.4 | 0.03 |
| 8 | 44.8 | 12.1 | 0.4 | 31.4 | 3.1 | 0.5 | 7.6 | 1.7 | 0.6 | 3.7 | 0.10 |
| 9 | 42.4 | 6.1 | 4.3 | 44.3 | 1.4 | 0.1 | 1.4 | 0.0 | 0.9 | 7.0 | 0.03 |
| 10 | 44.2 | 7.4 | 0.1 | 41.9 | 2.3 | 0.1 | 4.0 | 0.0 | 0.9 | 5.9 | 0.05 |
| 11 | 37.6 | 11.4 | 2.1 | 39.3 | 1.6 | 2.6 | 5.5 | 0.0 | 0.8 | 3.3 | 0.04 |
| 12 | 38.0 | 16.8 | 0.2 | 41.0 | 1.5 | 0.2 | 2.3 | 4.0 | 0.8 | 2.3 | 0.04 |
| 13 | 44.3 | 7.9 | 0.1 | 43.4 | 2.9 | 0.1 | 1.3 | 1.6 | 0.9 | 5.6 | 0.07 |
| 14 | 44.8 | 11.2 | 0.1 | 40.1 | 1.4 | 0.1 | 2.2 | 2.0 | 0.7 | 4.0 | 0.04 |

^{a}the percentage of individual oxides when a sum of SiO₂, Al₂O₃, Fe₂O₃, CaO, MgO, Na₂O and K₂O is 100%, and “Others” refer to a content of other chemical components in the clinker.

### (2) Hydration and Curing of Cement Ingredients

Analytically-pure NaOH and/or KOH was/were dissolved in as little water as possible and cooled to room temperature. NaOH, KOH or a combination thereof was added such that a weight ratio of NaOH+0.713KOH to the clinker was 0-0.03:1. The clinker powder was added in the alkaline solution and stirred for 2-5 min to obtain a slurry. Water was added in the slurry during stirring to reduce the slurry consistency such that the slurry was liquefied during subsequent vibration. The slurry was placed in a 40×40×40 cubic steel mold and vibrated to compact. The slurry as well as the mold was placed into a standard cement curing box and cured at 20° C. and ≥90% humidity for 1 day followed by demolding to obtain a cement paste test block. In a case where a strength of the slurry did not meet a demolding requirement after 1 day of curing, the demolding was delayed, and the slurry was cured in moisture for 7 days and then soaked in water for 28 days. An unconfined compressive strength of the test block at 3 days, 7 days and 28 days was tested respectively. The ingredients and compressive strength of the cement paste were shown in Table 4. It can be seen from Table 4 that the resulting clinker powder exhibits a certain self-gelling property, that is, it can be solidified by only adding water and has excellent compressive strength. Moreover, the strength of cement increases with the increase of the alkali content. A maximum compressive strength of the cement paste after 28 days reaches 106.0 MPa.

TABLE 4
Ingredients and compressive strength of cement paste
at different ages after room temperature curing

| | Cement paste | | | | | |
|---|---|---|---|---|---|---|
| | composition | | | | | |
| | Mass ratio to | | | Compressive strength at | | |
| Clinker | clinker (wt. %) | | Liquid/solid | different ages (MPa) | | |
| No. | NaOH | KOH | ratio | 3 days | 7 days | 28 days |
| 1 | 0.5 | 0.5 | 0.29 | 7.2 | 11.3 | 21.6 |
| | 1.0 | 1.0 | 0.29 | 14.5 | 18.6 | 37.0 |
| | 3.0 | 0 | 0.29 | 48.1 | 62.3 | 88.5 |
| 2 | 0 | 1.0 | 0.25 | 21.1 | 26.2 | 56.7 |
| | 2.0 | 0 | 0.25 | 28.3 | 35.9 | 67.9 |
| 3 | 0 | 1.0 | 0.25 | 29.7 | 40.8 | 50.8 |
| 4 | 0 | 0 | 0.25 | 1.5 | 2.8 | 13.1 |
| | 0 | 2.0 | 0.25 | 35.9 | 55.6 | 62.8 |
| 5 | 0 | 0 | 0.22 | 5.1 | 13.5 | 25.6 |
| | 1.0 | 1.0 | 0.22 | 23.9 | 49.7 | 68.5 |
| | 0 | 4.0 | 0.22 | 34.1 | 65.8 | 86.6 |
| 6 | 2.0 | 0 | 0.29 | 40.8 | 60.9 | 76.3 |
| 7 | 0 | 1.0 | 0.28 | 19.5 | 26.4 | 33.1 |
| | 0 | 3.0 | 0.29 | 35.8 | 48.2 | 65.4 |
| 8 | 1.0 | 0 | 0.27 | 12.2 | 18.6 | 26.9 |
| | 2.0 | 0 | 0.28 | 18.8 | 19.8 | 31.5 |
| 9 | 2.0 | 0 | 0.28 | 13.5 | 23.7 | 32.8 |
| 10 | 1.0 | 0 | 0.26 | 15.6 | 26.4 | 31.4 |
| 11 | 0.5 | 0 | 0.26 | 11.2 | 21.3 | 26.7 |
| 12 | 2.0 | 0 | 0.25 | 24.8 | 48.5 | 64.8 |
| 13 | 2.0 | 0 | 0.28 | 30.4 | 73.9 | 106.0 |
| 14 | 2.0 | 0 | 0.28 | 52.6 | 61.4 | 88.5 |
| | 0.5 | 0 | 0.28 | 37.8 | 47.2 | 70.1 |

What is claimed is:

1. A method for preparing a general-purpose cement, comprising:
step (1) mixing one or more raw materials to obtain a raw meal containing SiO₂, Al₂O₃, CaO, MgO, and Na₂O or K₂O; and subjecting the raw meal to drying and grinding to obtain a raw meal powder;
step (2) oxidatively calcining the raw meal powder at no less than 1210° C. for a time long enough to obtain a stable phase state, followed by cooling to obtain a clinker predominated by a glass phase;
wherein a mass percentage of SiO₂+Al₂O₃+Fe₂O₃+CaO+MgO+Na₂O+K₂O in the clinker is no less than 93%, and in every 100 parts (by mass) of SiO₂+Al₂O₃+Fe₂O₃+CaO+MgO+Na₂O+K₂O, a mass distribution is: SiO₂ 31.5˜44.8, Al₂O₃ 6.1˜19.9, Fe₂O₃0˜6.2, CaO 22.5˜45.0, MgO 1.2˜16.0, Na₂O+K₂O 1.0˜8.3; and
step (3) mixing the clinker with NaOH, KOH or a combination thereof followed by grinding to obtain the general-purpose cement; or
grinding the clinker to obtain a clinker powder, and mixing the clinker powder with a NaOH aqueous solution, a KOH aqueous solution or a combination thereof for use;
wherein NaOH, KOH or a combination thereof is added such that a weight ratio of NaOH+0.713KOH to the clinker is 0-0.03:1.

2. The method of claim 1, wherein in the clinker, a weight ratio of CaO+MgO to SiO₂+Al₂O₃ is 0.6-1.0:1.

3. The method of claim 1, wherein in the clinker, a weight ratio of SiO₂ to Al₂O₃ is 2.0-7.0:1.

4. The method of claim 1, wherein in the clinker, a weight ratio of MgO to CaO is 0.03-0.66:1.

5. The method of claim 1, wherein in step (2), the cooling is performed by air blast cooling or water quenching.

6. The method of claim 1, wherein in step (3), a weight percentage of a sieve residue of the general-purpose cement is no more than 5% after passing through a 75-μm square hole sieve; and
a weight percentage of a sieve residue of the clinker powder is no more than 5% after passing through the 75-μm square hole sieve.
